(19) United States
(12) Patent Application Publication
(10) Pub. No.: US 2009/0256095 A1
(43) Pub. Date: Oct. 15, 2009

(54) Locomotive Air Compressor Crankcase with Oil Drain Valve

(75) Inventors: H. George Osterwise, Greensburg, PA (US); Matthew D. Mitsch, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Wabtec Holding Corp., Wilmerding, PA (US)

(21) Appl. No.: 12/101,191

(22) Filed: Apr. 11, 2008

(51) Int. Cl. F16N 31/00; F16N 1/00; F16K 5/00

(52) U.S. Cl. 251/144; 251/315.01; 29/888.02

(57) ABSTRACT

A crankcase for a locomotive air compressor including a body defining an interior space, a port in fluid communication with the interior space of the body, a valve receiving portion adjacent to and surrounding the port, and an oil drain valve engaged with the valve receiving portion and having a flow passageway in fluid communication with the port. The oil drain valve has an open position and a closed position, such that the oil drain valve in the open position allows oil to flow from the interior space of the body through the flow passageway, and the oil drain valve in the closed position prevents the flow of oil from the interior space of the body through the flow passageway. A method for installing a locomotive air compressor having the crankcase and oil drain valve is also disclosed.

### BACKGROUND OF THE INVENTION

1. Field of the Invention

The present invention relates to a locomotive air compressor crankcase and, more particularly, a crankcase having an oil drain valve.

2. Description of Related Art

Air compressors are used on freight, passenger, and switcher locomotives for supplying compressed air to the locomotive, train brake operation, and all other pneumatic systems on the locomotive. Typically, the air compressors have a pair of low-pressure cylinders and a high-pressure cylinder mounted on and supported by a crankcase and contains pistons which are actuated by connecting rods driven by a rotary crankshaft. The exterior portion of the crankcase generally includes two tapped ports that are plugged prior to installation of the compressor in the locomotive. Upon installation of the compressor, the end-user typically removes one of the plugs from the tapped port and installs piping and a drain valve downstream of the compressor.

Since the plug needs to be removed in order to install the piping and drain valve, the compressors are generally shipped to the end-user without oil in the crankcase. Requiring the end-user to add the oil to the crankcase may lead to certain inefficiencies and problems. In addition to the compressor assembly, the end-user is generally responsible for assembling a large number of components that form the locomotive. Removing the plug and adding the oil to the crankcase after installation of the compressor is another step in the assembly process which takes time and hampers productivity. Furthermore, the end-user of the compressor may use an inadequate amount of oil, which can lead to premature failure of the compressor.

### SUMMARY OF THE INVENTION

In one embodiment, a crankcase for a locomotive air compressor is disclosed including a body defining an interior space and comprising a port in fluid communication with the interior space of the body, a valve receiving portion adjacent to and surrounding the port, and an oil drain valve engaged with the valve receiving portion and having a flow passageway in fluid communication with the port. The oil drain valve has an open position and a closed position, such that the oil drain valve in the open position allows oil to flow from the interior space of the body through the flow passageway, and the oil drain valve in the closed position prevents the flow of oil from the interior space of the body through the flow passageway. In one example, the oil drain may be a ball valve.

In one aspect, the valve receiving portion includes a substantially flat area, an annular depression adapted to secure an o-ring, and a recessed area for housing at least a portion of the oil drain valve. The body of the compressor may also include a second port in fluid communication with the interior space of the body, a plug fitting receiving portion, and a plug fitting engaged with the plug fitting receiving portion and in fluid communication with the second port. The plug fitting is adapted to receive a plug for preventing the flow of oil through the second port.

In another aspect, the oil drain valve has a flange with through holes, the valve receiving portion has threaded holes corresponding to and aligned with the through holes in the flange, and bolts may be inserted through the through holes in the flange to engage the threaded holes of the valve receiving portion for securing the oil drain valve to the valve receiving portion.

Another embodiment described herein relates to a method for installing a compressor on a locomotive. The method includes a step of providing a compressor for a locomotive, where the compressor has a crankcase including a body defining an interior space, a port in fluid communication with the interior space of the body, a valve receiving portion adjacent to and surrounding the port, and an oil drain valve engaged with the valve receiving portion and having a flow passageway in fluid communication with the port. The method includes the steps of adding oil to the crankcase and installing the compressor on a compressor platform located on the locomotive. In another aspect, the method may include a step of securing a drain pipe to the oil drain valve for transporting drained oil away from the compressor. The method may further include the step of transitioning the oil drain valve between a closed position and an open position. The body may further comprise a second port in fluid communication with the interior space of the body, a plug fitting receiving portion, and a plug fitting engaged with the plug fitting receiving portion and in fluid communication with the second port, and the method may further comprise inserting a plug into the plug fitting for preventing the flow of oil through the second port.

Further details and advantages will become clear upon reading the following detailed description in conjunction with the accompanying drawings.

### BRIEF DESCRIPTION OF THE DRAWINGS

FIG. 1 is a perspective view of a locomotive air compressor crankcase pursuant to one embodiment, showing an oil drain valve in a closed position;

FIG. 2 is a partial perspective view of the crankcase showing Detail A of FIG. 1;

FIG. 3 is an exploded perspective view of the oil drain valve associated with the crankcase shown in FIG. 1;

FIG. 4 is a partial top view of the crankcase of FIG. 1 wherein the oil drain valve and plug fitting are located;

FIG. 5 is a partial front view of the crankcase of FIG. 1 wherein the oil drain valve is located;

FIG. 6 is a cross-sectional view taken along line of A₁-A₁ in FIG. 5;

FIG. 7 is a perspective view of the locomotive air compressor crankcase of FIG. 1, showing an oil drain valve in an open position;

FIG. 8 is a partial perspective view of the crankcase showing Detail B of FIG. 7;

FIG. 9 is a top view of a portion of the crankcase of FIG. 7 wherein the oil drain valve is located and disposed in an open position;

FIG. 10 is a partial front view of the portion of the crankcase shown in FIG. 7 wherein the oil drain valve is located and disposed in a open position;

FIG. 11 is a cross-sectional view taken along the line of A₂-A₂ shown in FIG. 11.

### DESCRIPTION OF PREFERRED EMBODIMENTS

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices illustrated in the accompanying drawing figures and described herein are simply exemplary and should not be considered as limiting.

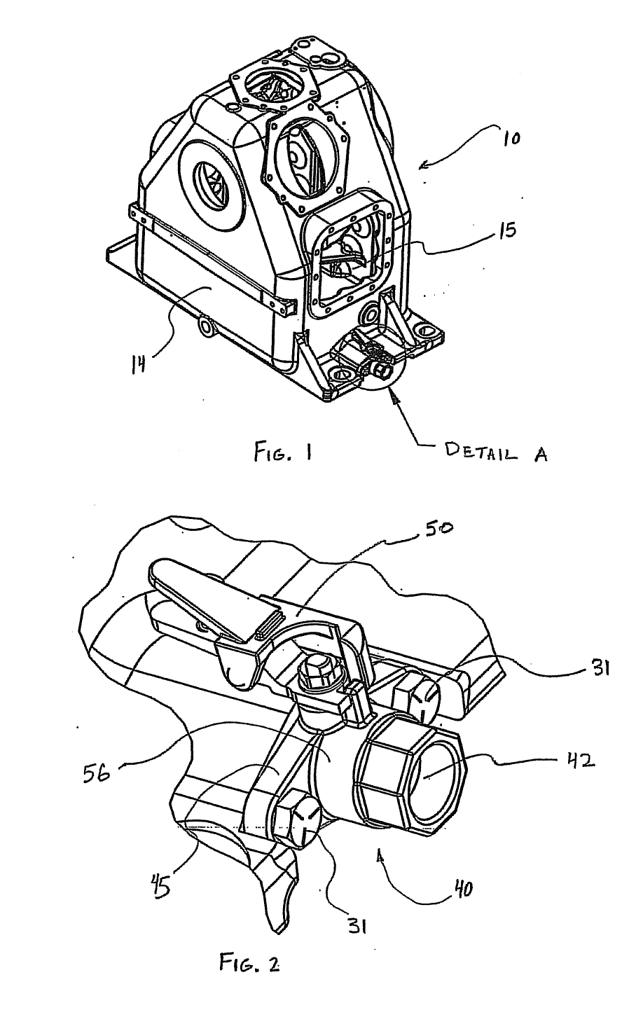

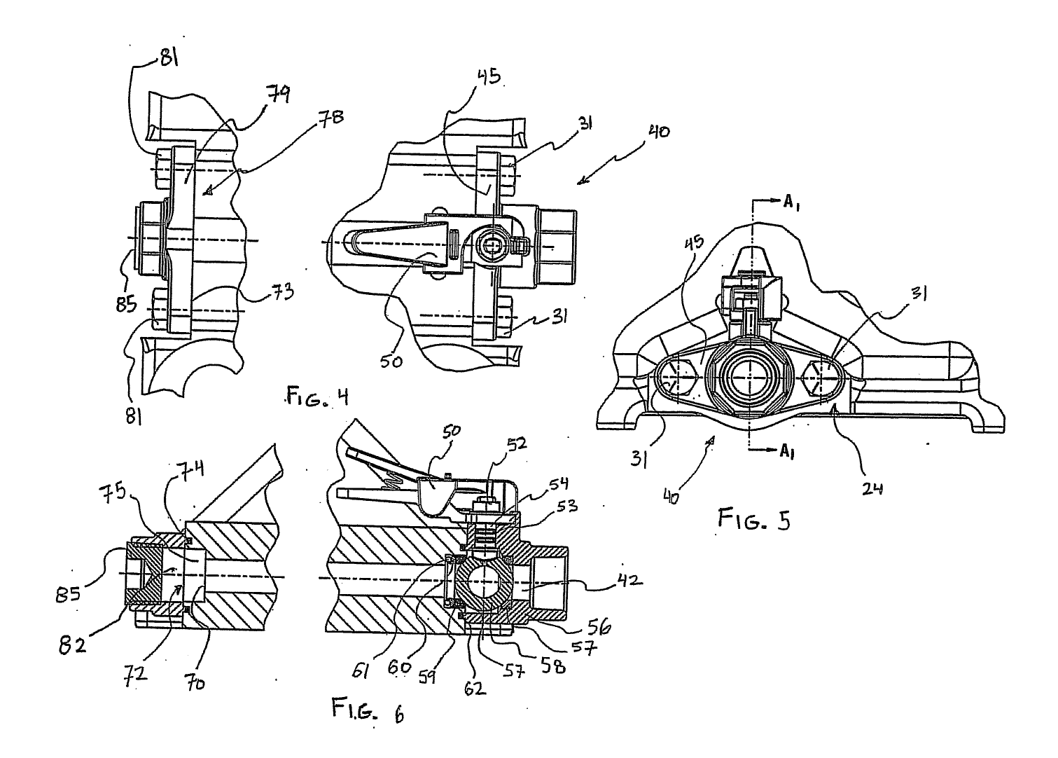

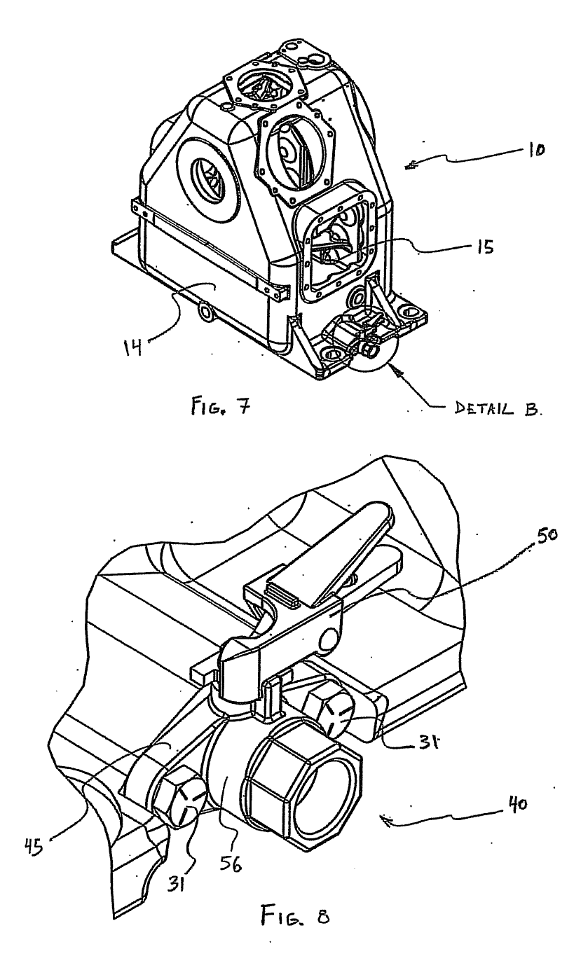

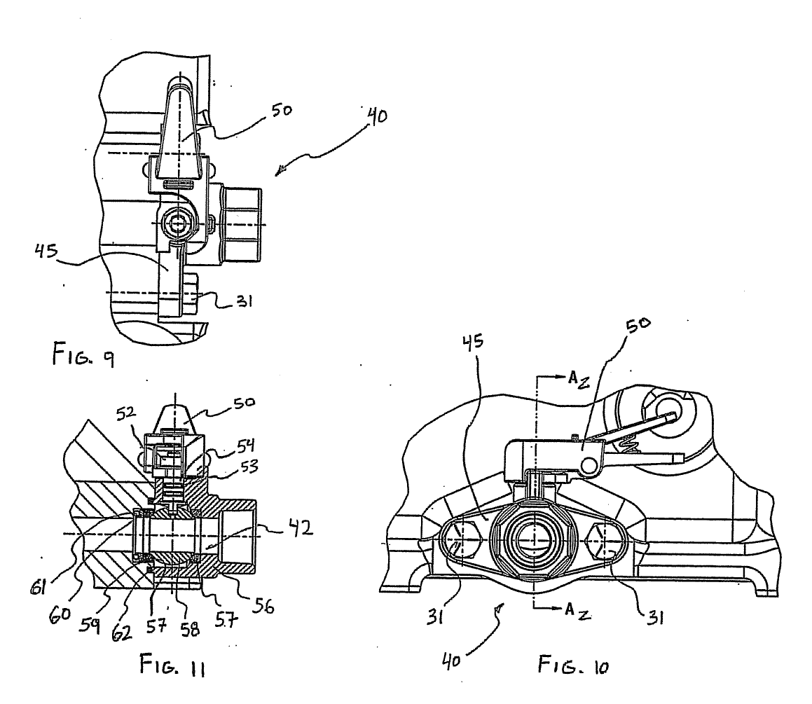

According to one embodiment shown in FIGS. 1-11, a crankcase 10 for a locomotive air compressor includes a body or housing 14 defining an interior space 15, a port 20 in fluid communication with the interior space 15 of the body 14, a valve receiving portion 24 adjacent to and surrounding the port 20, and an oil drain valve 40 engaged with the valve receiving portion 24 and having a flow passageway 42 adapted to be selectively placed in fluid communication with the port 20. The oil drain valve 40 has a closed position, as shown in FIG. 2, and an open position, as shown in FIG. 8. When the oil drain valve 40 is in the closed position, as shown generally in FIGS. 1-6, oil that is located in the interior space 42 of the body 14 of the crankcase 10 is prevented from flowing or exiting through the flow passageway 42 of the oil drain valve 40. When the oil drain valve 40 is in an open position, as shown generally in FIGS. 7-11, oil that is located in the interior space 42 of the body 14 of the crankcase 10 can flow from the interior space 42 through the port 20 and flow passageway 42, and vice versa if desired.

The oil drain valve 40 may be a ball-style valve, as shown in FIGS. 1-11, including a valve body 56, a flange 45 extending from the valve body 56 and having a pair of through holes 46, a stem 54 having a pair of sealing o-rings 53, and a handle 50 attached to the stem 54 via a nut 52 and lock washer 51. The oil drain valve 40 may further include valve seats 57, a ball 58, a seat seal o-ring 59, a disk 60, a spring 61, and a housing o-ring 62.

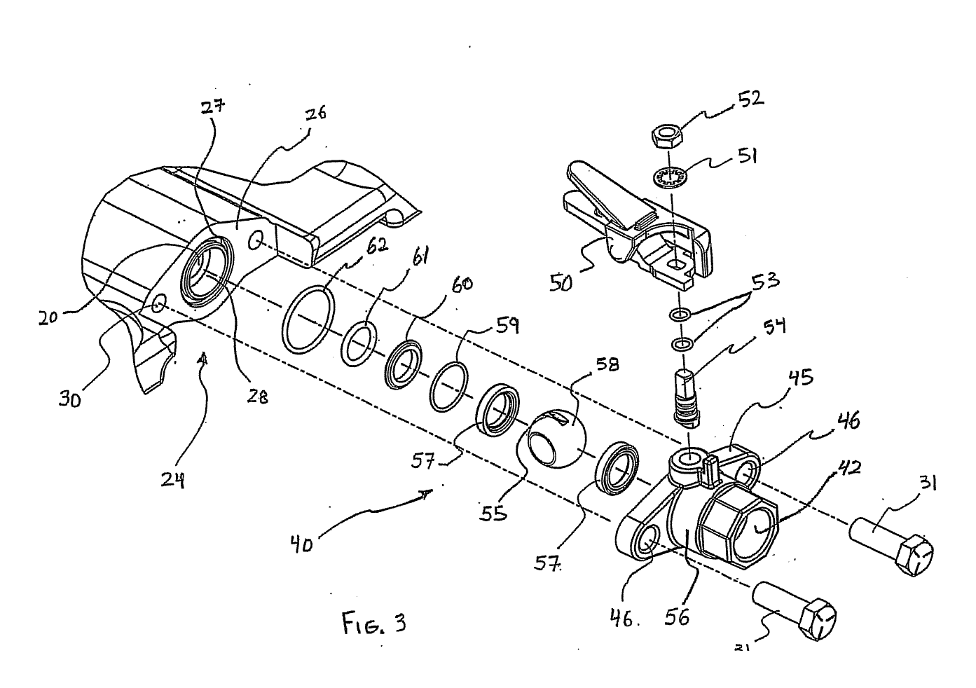

The valve receiving portion 24 may include a substantially flat area 26, an annular depression 27 adapted to receive an o-ring, and a recessed area 28 for housing at least a portion of the oil drain valve 40. As shown in FIGS. 3, 6, and 11, the substantially flat area 26 may be a machined surface on the lower part of the crankcase 10 surrounding the port 20. Further, the valve receiving portion 24 may include a pair of threaded holes 30.

In the illustrated embodiment, as shown in FIG. 3, one of the ball seats 57 is placed into the valve body 56, and the o-rings 53 are located on a pair of grooves on the stem 54. The stem 54 with the o-rings 53 is inserted into the valve body 56. The ball 58 is placed in the valve body 56 and engages the valve seat 57 already located in the valve body 56. The ball 58 has a groove 55 that is mated with a tang on the bottom of the stem 54. The housing o-ring 62 is placed in the annular depression 27 to ensure a proper seal between the valve body 56 and the valve receiving portion 24. The spring 61 is shaped and dimensioned to fit in the recessed area 28 of the valve receiving portion 24. The disk is then placed in the recessed area 28 and engages the spring 61. The seat seal o-ring is placed into a groove of the disk and the other seat 57 is inserted into the recessed area 28 against the disk 60 and seat seal o-ring 59. The valve body 56 is placed against the valve receiving portion 24 such that the through holes 46 in the flange 45 correspond to and align with the threaded holes 30 of the valve receiving portion 24. The valve body 56 is secured to the valve receiving portion 24 via a pair of bolts 31 inserted into the through holes 46 for engagement with the threaded holes 30. The handle 50, as shown in FIG. 3, is attached to the stem 54 via nut 52 and lock washer 51. The handle 50, however, may be secured to the stem 54 by any other suitable arrangement. For example, the nut 52 may be used by itself with a thread locking compound.

In certain embodiments, as shown in FIGS. 4-6, the body 14 of the crankcase 10 may include a second port 70 in fluid communication with the interior space 15 of the body 14. Also, the body 14 may include a plug fitting receiving portion 72, and plug fitting 78 engaged with the plug fitting receiving portion 72 and in fluid communication with the second port 70. The plug fitting receiving portion 72 includes a substantially flat area 73, an annular depression 74, and a recessed area 75. Further, the plug fitting may include a flange with a pair of through holes (not shown) that correspond to a pair of threaded holes (not shown) on the plug fitting receiving portion 72, and flow passageway 82 aligned with the second port 70. The plug fitting receiving portion 78 is adapted to receive a plug 85, such that the plug blocks the flow passageway 82 preventing the flow of oil from the interior space 15 of the body through the flow passageway 82. A pair of bolts 81 inserted into the through holes of the flange 79 secures the plug fitting 78 to the plug fitting receiving portion 72.

In certain embodiments, the plug fitting receiving portion 72 is substantially similar to and corresponds to the valve receiving portion 24. Therefore, the plug fitting 78 may be removed from the plug fitting receiving portion 72 and the oil drain valve 40 could be secured to the plug fitting receiving portion 72 in the same manner as described hereinabove. Accordingly, two oil drain valves 40 may be associated with crankcase 10. Manufacturing the crankcase 10 with the plug fitting receiving portion 72 and the valve receiving portion 24 at different locations on the crankcase 10, for example, on opposing sides, allows flexibility in the location of the oil drain valve 40. After machining the plug fitting receiving portion 72 and the valve receiving portion 24 on the crankcase, the oil drain valve 40 can subsequently be secured to one of multiple positions on the crankcase 10 (i.e., on either side or two valves 40 may be utilized). The plug fitting 78 can then be installed where the oil drain valve 40 is not located. Furthermore, if an air compressor and crankcase 10 is removed from the locomotive for repair or overhaul service, the plug fitting receiving portion 72 and the valve receiving portion 24 may allow for the compressor to be installed on a locomotive requiring a different location for the oil drain valve 40. The plug fitting receiving portion 72 and the valve receiving portion 24 may also allow the oil drain valve to be located at a different position on the crankcase 10 while the crankcase 10 and compressor are still on the locomotive platform.

Although the oil drain valve 40 is shown where the handle 50 is generally parallel or inline with flow passageway 42 in the closed position, as shown in FIGS. 1-6, and perpendicular to the flow passageway 42 in the open position, as shown in FIGS. 7-11, the handle 50 may include other orientations corresponding to the open and closed positions of the oil drain valve 40. For instance, the handle 50 may be positioned perpendicular to the flow passageway 42 in the closed position and inline with the flow passageway 42 in the open position.

Furthermore, although a ball-type valve is shown and described herein, any suitable valve style or type may be adapted for attachment to the valve receiving portion 24, including but not limited to gate, globe, or butterfly style valves. In such cases, the valve receiving portion 24 on the crankcase 10 would be manufactured or machined to correspond to a portion or section of the particular valve that was chosen.

According to another embodiment, a locomotive air compressor is provided with a crankcase 10 including a body 14 having an interior space 15, a port 20 in fluid communication with the interior space 15 of the body 14, a valve receiving portion 24 adjacent to and surrounding the port 20, and an oil drain valve 40 engaged with the valve receiving portion 24 and having a flow passageway 42 in fluid communication with the port 20. The oil drain valve has an open position and a closed position. The crankcase 10 may be integrated with any suitable locomotive air compressor such as a two stage, three cylinder “W” configuration, single acting air compressor that may be driven directly from the locomotive's diesel engine through appropriate couplings and driveshaft, belt driven by an electric motor, or driven from an electric motor directly mounted to the compressor. Prior to installing the air compressor and crankcase 10 on the locomotive, the oil drain valve 40 is oriented in the closed position and oil may be added to the crankcase 10. The air compressor and crankcase 10 is then installed on a compressor platform or other suitable mounting location on the locomotive. Additionally, a drain pipe may be secured to the oil drain valve 40 for routing drained oil from the crankcase 10 to a position underneath the deck of the locomotive and into an oil receptacle. The oil may also be routed to different areas of the locomotive.

While certain embodiments of a locomotive air compressor crankcase were described in the foregoing detailed description, those skilled in the art may make modifications and alterations to these embodiments without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A crankcase for a locomotive air compressor comprising:
a body defining an interior space and comprising a port in fluid communication with the interior space of the body;
a valve receiving portion adjacent to and surrounding the port; and
an oil drain valve engaged with the valve receiving portion and having a flow passageway in fluid communication with the port.

2. The crankcase for a locomotive air compressor in accordance with claim 1, wherein the oil drain valve has an open position and a closed position, such that the oil drain valve in the open position allows oil to flow from the interior space of the body through the flow passageway, and the oil drain valve in the closed position prevents the flow of oil from the interior space of the body through the flow passageway.

3. The crankcase for a locomotive air compressor in accordance with claim 1, wherein the valve receiving portion includes a substantially flat area, an annular depression adapted to secure an o-ring, and a recessed area for housing at least a portion of the oil drain valve.

4. The crankcase for a locomotive air compressor in accordance with claim 1, wherein the body further comprises a second port in fluid communication with the interior space of the body, a plug fitting receiving portion, and a plug fitting engaged with the plug fitting receiving portion and in fluid communication with the second port.

5. The crankcase for a locomotive air compressor in accordance with claim 4, wherein the plug fitting is adapted to receive a plug for preventing the flow of oil through the second port.

6. The crankcase for a locomotive air compressor in accordance with claim 4, wherein the fitting receiving portion includes a substantially flat area, an annular depression adapted to secure an o-ring, and a recessed area.

7. The crankcase for a locomotive air compressor in accordance with claim 1, wherein the oil drain valve has a flange with through holes, the valve receiving portion has threaded holes corresponding to and aligned with the through holes in the flange, and bolts inserted through the through holes in the flange engage the threaded holes of the valve receiving portion for securing the oil drain valve to the valve receiving portion.

8. The crankcase for a locomotive air compressor in accordance with claim 1, wherein the oil drain valve comprises a ball valve.

9. A crankcase for a locomotive air compressor comprising:
a body having an interior space and comprising a port in fluid communication with the interior space of the body; and
an oil drain valve having a flow passageway substantially aligned with the port.

10. The crankcase for a locomotive air compressor in accordance with claim 9, wherein the oil drain valve has an open position and a closed position, such that the oil drain valve in the open position allows oil to flow from the interior space of the body through the flow passageway, and the oil drain valve in the closed position prevents the flow of oil from the interior space of the body through the flow passageway.

11. The crankcase for a locomotive air compressor in accordance with claim 9, wherein the oil drain valve has a flange with through holes, the body has a pair of threaded holes corresponding to and aligned with the through holes in the flange, and bolts inserted through the through holes in the flange engage the threaded holes of the body for securing the oil drain valve to the body.

12. The crankcase for a locomotive air compressor in accordance with claim 9, wherein the oil drain valve comprises a ball valve.

13. A method for installing a compressor on a locomotive comprising the steps of:
providing a compressor for a locomotive, wherein the compressor has a crankcase comprising a body defining an interior space, a port in fluid communication with the interior space of the body, a valve receiving portion adjacent to and surrounding the port, and an oil drain valve engaged with the valve receiving portion and having a flow passageway in fluid communication with the port;
adding oil to the crankcase; and
installing the compressor on a compressor platform located on the locomotive.

14. The method in accordance with claim 13, further comprising the step of securing a drain pipe to the oil drain valve for routing drained oil away from the compressor.

15. The method in accordance with claim 13, wherein the oil drain valve has an open position and a closed position, such that the oil drain valve in the open position allows oil to flow from the interior space of the body through the flow passageway, and the oil drain valve in the closed position prevents the flow of oil from the interior space of the body through the flow passageway.

16. The method in accordance with claim 15, further comprising the step of transitioning the oil drain valve between the closed position and the open position.

17. The method in accordance with claim 13, wherein the body further comprises a second port in fluid communication with the interior space of the body, a plug fitting receiving portion, and a plug fitting engaged with the plug fitting receiving portion and in fluid communication with the second port, the method further comprising inserting a plug into the plug fitting for preventing the flow of oil through the second port.

18. The method in accordance with claim 17, wherein the fitting receiving portion includes a substantially flat area, an annular depression adapted to secure an o-ring, and a recessed area.
